(19) United States
(12) Patent Application Publication
(10) Pub. No.: US 2008/0072164 A1
(43) Pub. Date: Mar. 20, 2008

(54) Methods and the Program-Recording Medium for Creating, Editing and Trading Home Page Components to Assemble a Home Page and a Personal Portal Site Directly in Wysiwyg on Web Browser

(76) Inventor: Heeseob Park, Seongnam (KR)

Correspondence Address: IPLA P.A., 3580 WILSHIRE BLVD., 17TH FLOOR, LOS ANGELES, CA, 90010, US

(21) Appl. No.: 11/570,497

(22) PCT Filed: Jun. 23, 2005
(86) PCT No.: PCT/KR05/01950

§ 371 Date: Dec. 12, 2006

(30) Foreign Application Priority Data
Jun. 24, 2004 (KR) 10-2004-0047912

(51) Int. Cl. G06F 3/048

(52) U.S. Cl. 715/762

(57) ABSTRACT

The present invention is a method to create and edit the home page component in WYSIWYG directly on a web browser by wrapping the HTML code of each home page component inside the div tag to be two fold structure, storing the position information and the content information in XML node on server side and regenerating the home page on user's demand. Further the present invention is a method to create the editable personal portal page by changing the personal bookmark favorites file in tree structure into bookmark folders displayed as lattice structure of bookmark folders on a web browser. Further the present invention is a method to trade each home page component between users. The said trading activates the creativity of users and the whole community of the site.

### TECHNICAL FIELD

The field of the present invention is the web application and service through internet.

### BACKGROUND ART

The previous methods of making home page are, just choosing among various home pages that the professional web disigner designed (korean patent 2002-0078633) or choosing among various home page components (head part, menubar, bookmarkfolder, bookmark, tail part) (korean patent 2002-0031501, korean patent 2003-0033439). But these methods are not convenient because the edition of the styles (position, size, background color, background image, border style, border color, text, bookmark) of each home page component were not done by WYSIWYG (What You See Is What You Get) method.

Meanwhile there are portal sites which classifies the bookmarks according to their class into each folder and make these folders as one directory page (hitpage.co.kr, gobestsite.co.kr). But these site does not provide any edition method of their bookmark folder and bookmarks, their users cannot insert their own bookmarks into where they want to.

Another inconvenience of previous method was that the home page components designed by the professional designers are displayed and the users just choose one of them and use it in their home page. In other word, there was no means by which the components can be traded among users. Therefore even when the user created a component of good design, the component could not be traded since there was no method for trading.

### DISCLOSURE

### Technical Problem

In order for the home page components to be created and edited by WYSIWYG method, the HTML document is divided into several part according to their function. The divided home page components are head part, menubar, advertisement, text box, bookmark folder, bookmarks, flash, applet, picture, table, label, tail part et cetra (drawing 1). In order for these devided home page components to be easily positioned and edited, the content of each component (B of drawing 6) is put inside the special node (from now on, “component node”)(A of drawing 6) to become a “two fold structure” (drawing 6). Each node for each component is given a class name which is classified according to its function.

In other words, after the prefabricated home page is divided according to its function in home page and is still fragmented into various components, in order for the HTML code of each component (content of component) to be placed in, new tag is added in front of and at the back of each component to become a new two fold structure node(component node)(drawing 7), in which the position information and content information are stored as a string at each position attribute and content attribute respectively and is recovered as a HTML component by processing XML (drawing 8) and XSL (drawing 8a) to make a whole HTML document on user's demand. The outer node has the position information at its attribute and the inner node has all the other information (or content information), that is to say, content and style information. The reason why this two fold structure is needed is explained below.

the edition of home page components can be classified into two types, the edition of the component itself and the edition of the style only. The editing these two types and saving the edited result separately as XML and XSL needs a professional XML editor. The normal plain HTML editor just add new tags to the existing tags and adding new attribute. This kind of edition results in a mixed HTML document with the content and the style. Therefore without the help of professional XML editor, it is hard to store the mixed HTML document seratately into its XML and XSL and restore it afterwards.

### Technical Solution

The present invention solved this problem by storing the inner content mixed with style as string at the attribute of XML node and restoring it by placing the inner content in the outer node(component node). The thing which is stored as a string at the attribute in XML node is not parsed but just treated as a whole string when processed with XSL. By this method disclosed in the present invention, no matter what kind of tag is added to the content of the inner component, the outer node is maintained without any change and this enables the HTML document to be restored without any error in each component's function. The other reason why this kind of two fold structure is needed is that when the edition mode is activated in a web browser, the inner content becomes editable. Therefore if the inner content is placed inside of the outer node as a child, then the whole part of the inner content can be edited.

To describe the present invention further, lets see an example as follows. If the inner content is “<table> TABLE_STRUCTURE</table>”, this HTML code is store as a child in the outer component node “<div class=‘folder’ style=‘left:10; top:20; position:absolute;’></div>” to become the following. “<div class=‘folder’ style=‘left:10; top:20; position:absolute;’><table> TABLE_STRUCTURE</table></div>”.

Any tag can be the tag for the component node. But in this present invention <div></div> tag which has width and height attribute is used for the component node tag.

On server side there is an XML node (drawing 2) corresponding to each component node in order to store and manage each component. For example, in case of “bookmarkfolder” node, “<bookmarkfolder></bookmarkfolder>” stored the position information and the content information at the position attribute and at the content attribute respectively.“<bookmarkfolder position=‘left:10; top:20; position:absolute;’ content=‘<table>TABLE_STRUCTURE</table>’></bookmarkfolder>” (drawing 8).

In this example, the string of the content is shown as ‘<table>TABLE_STRUCTURE</table>’. But this is just for easy understanding. In practice the HTML tags are converted and stored as a string like this: ‘&lt;table&gt;TABLE_STRUCTURE&lt;/table&gt;’. This principle is applied to all the other HTML tags inside quotation mark (′).

When these XML is processed with XSL (drawing 8a), XSL create <div></div> node corresponding to the XML node and place the position attribute in this div node. “<div style=‘left:10; top:20; position: absolute;’></div>”. After this, the div node is given a class name. “<div class=‘folder’ style=‘left:10; top:20; position: absolute;’></div>”. At the last step, the content attribute is placed inside of the dive node as a content. “<div class=‘folder’ style=‘left:10; top:20; position: absolute;’><table>TABLE_STRUCTURE</table></div>”. The final result is sent to a web browser and shown as HTML document on a web browser.

### Advantageous Effects

With the two fold structure of the present invention, the HTML code designed by a professional designer can be stored as an inner content in two fold structure without any special treament. The HTML code is stored as an attribute of XML node, the HTML code mixed with content and style can be easily stored and restored in XML node.

With the WYSWYG edition method of a home page component disclosed by the present invention, the normal user without any professional knowledge of edition can create any home page easily.

The present invention displays the personal favorite bookmarks in folders arranged in lattice structure not in tree structure and makes the personal favorite bookmarks into a personal portal page in which one can access any site with just one click and can edit the bookmarks easily if one wants to.

With the present invention, the trade of home page component is easily done between the users, which contributes to willingness of creation of home page component of good design and to the activation of the community site.

### DESCRIPTION OF DRAWINGS

FIG. 1 is an exemplary home page assembled with home page components.

FIG. 2 is an XML document structure storing home page components.

FIG. 3 is an exemplary database storing home page components.

FIG. 4 is an exemplary context menu for edition shown on a web browser.

FIG. 5 is an exemplary personal portal page which can be editable.

FIG. 6 is an illustration of the two fold structure which the present invention discloses: A is the outer tag of component node; B is the inner HTML code of component node.

FIG. 7 is an exemplary bookmark folder having two fold structure.

FIG. 8 is an exemplary XML node storing home page component.

FIG. 8a is an exemplary XSL node used to regenerate a home page component.

FIG. 8b is an illustration of HTML code of personal bookmark favorites.

FIG. 8c is an string array into which the HTML code of FIG. 8b is changed.

FIG. 8d is an XML nodes into which the string array of FIG. 8c is changed.

FIG. 9 is a sequence diagram of the string-replacing method which changes personal bookmark favorites into a string array.

FIG. 10 is a sequence diagram of the string-replacing method which changes the string array into XML nodes.

FIG. 11 is a sequence diagram of registration of components by seller.

FIG. 12 is a sequence diagram of purchase of components by buyer.

FIG. 13 is an exemplary XML node having seller attribute.

FIG. 14 is a block diagram illustrating the trade of components between users.

FIG. 15 is an exemplary XML node storing the purchased component.

FIG. 16 is an illustration of the whole system for making an assemblied home page on network.

FIG. 17 is a sequence diagram of events for making an assemblied home page without a separate edition option window.

FIG. 18 is a sequence diagram of events for making an assemblied home page with a separate edition option window.

FIG. 19 is an illustration of whole system for making a personal portal on network.

FIG. 20 is a sequence diagram of events for making personal portal on network.

FIG. 21 is a sequence diagram of events for trading the home page components between users.

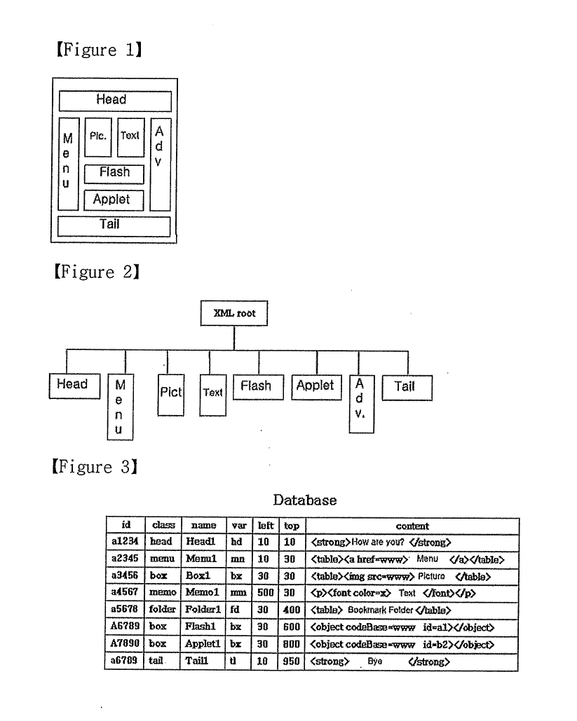

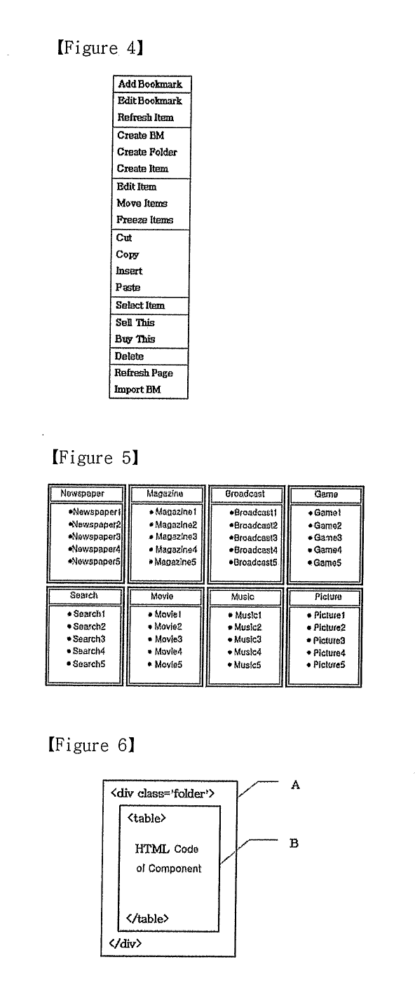

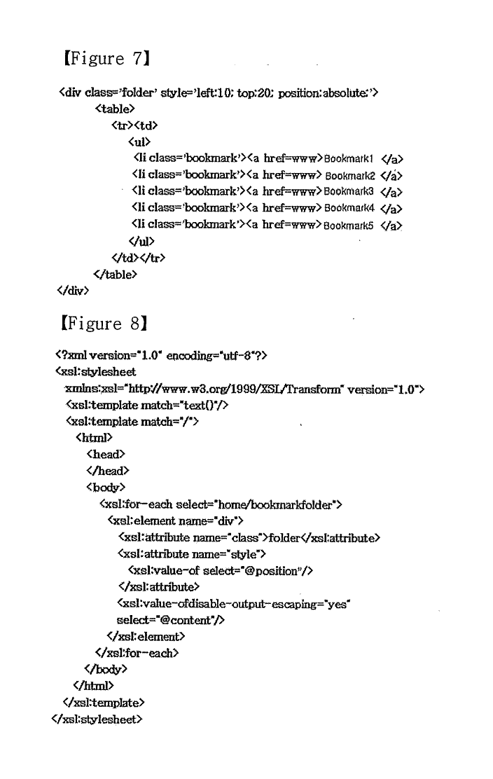

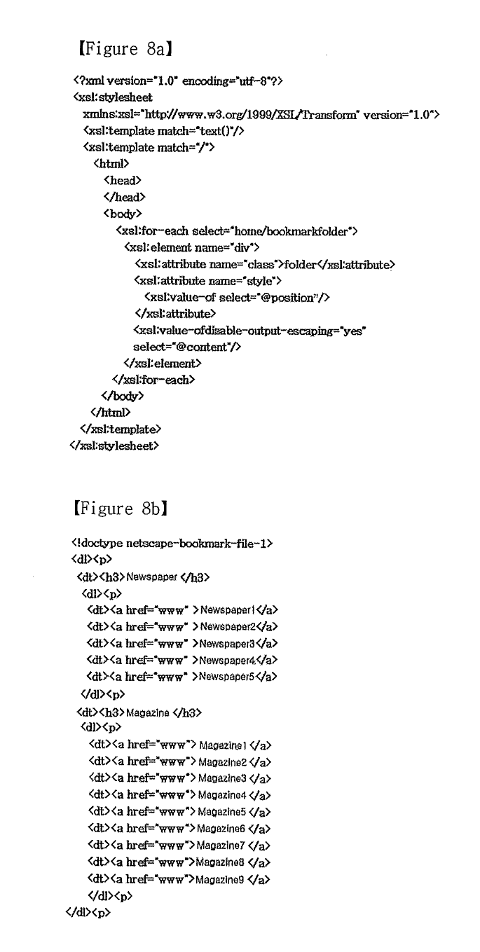

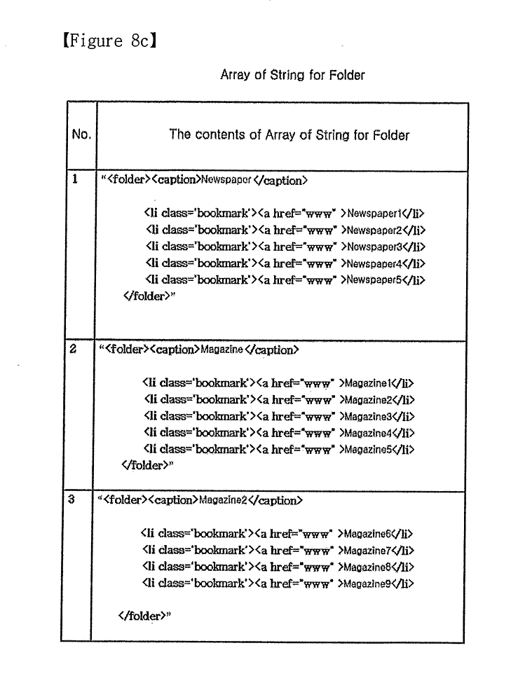

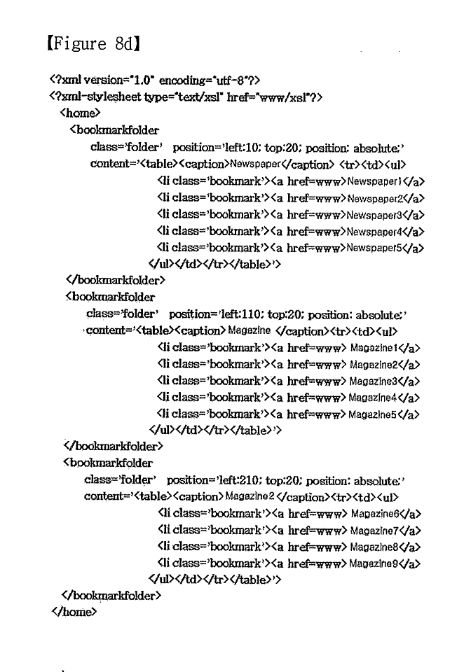

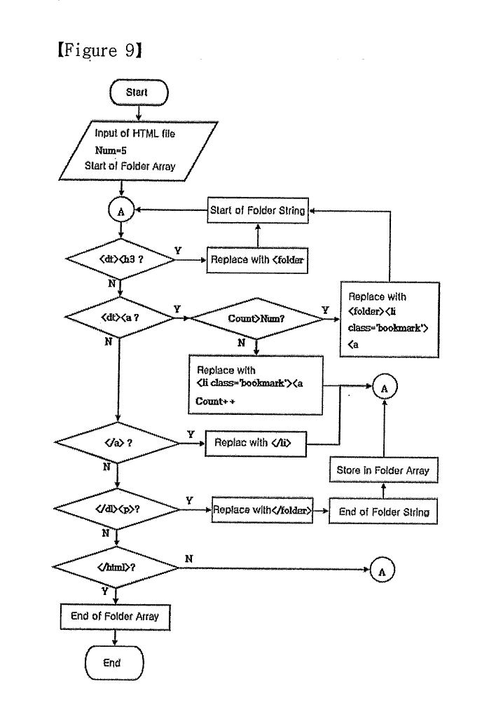

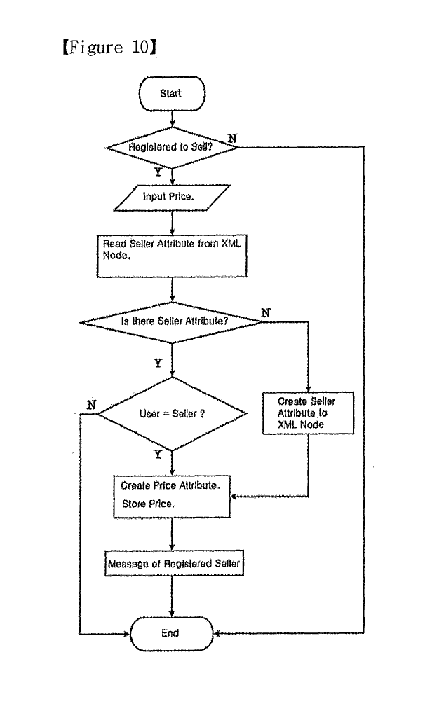

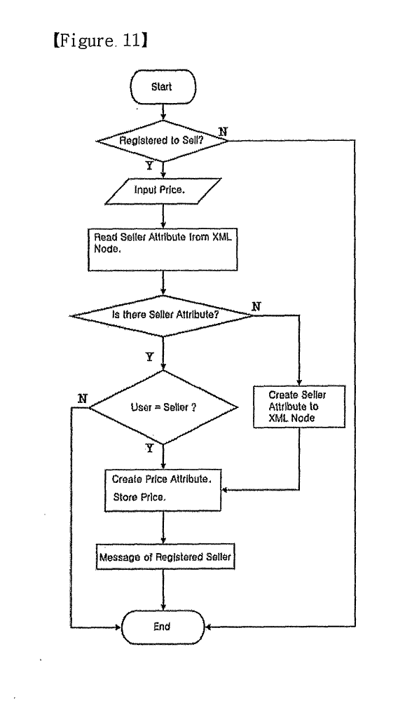

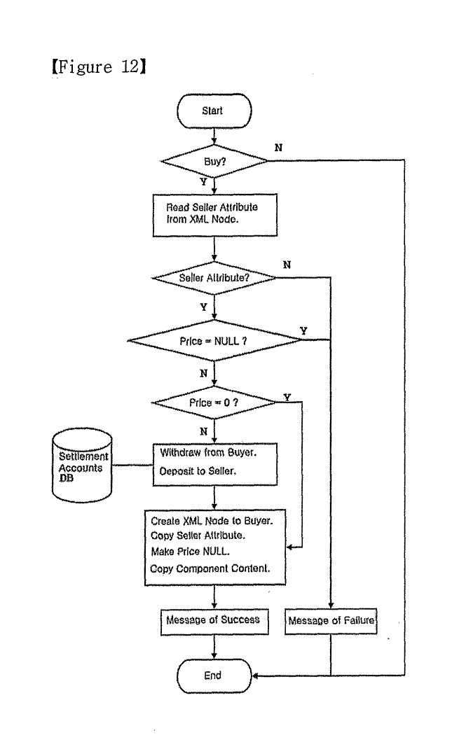

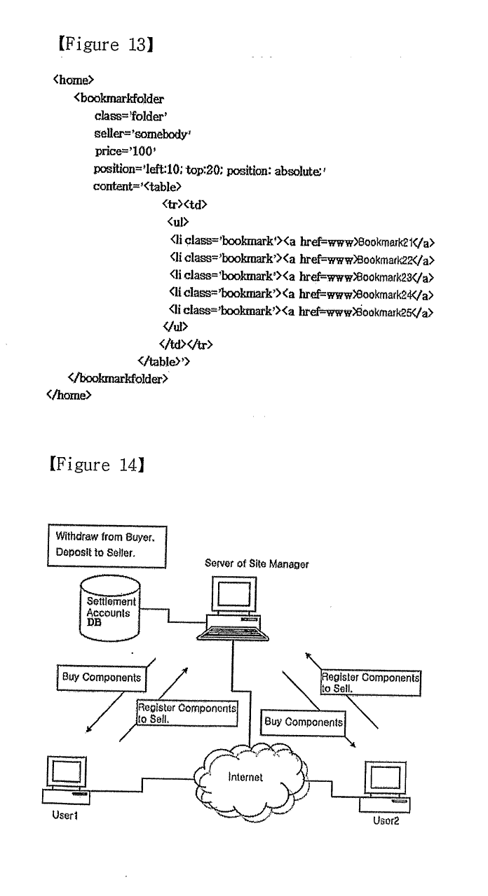

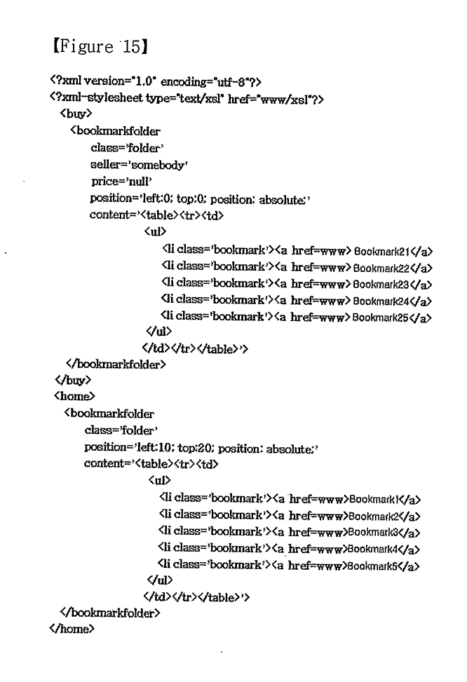

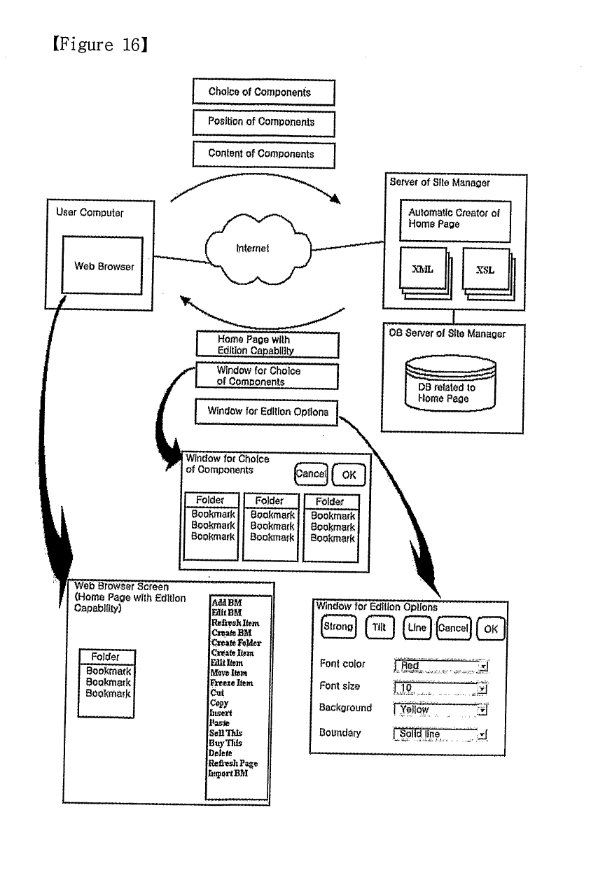

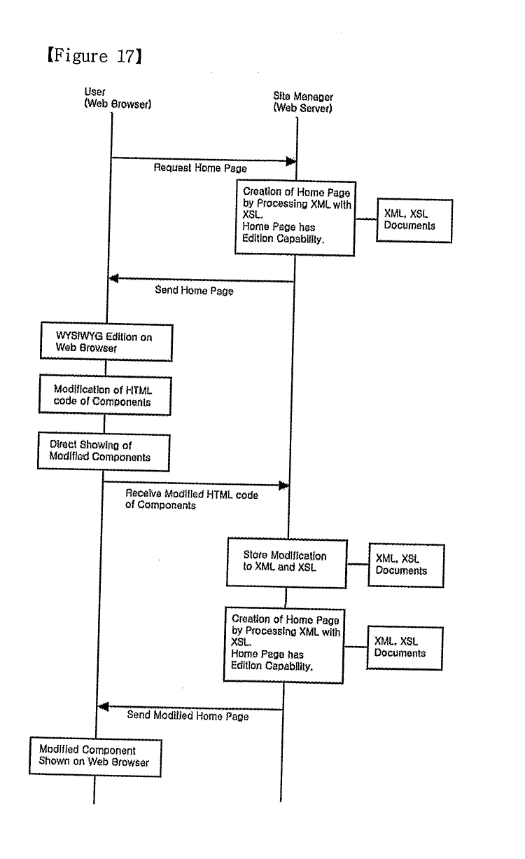

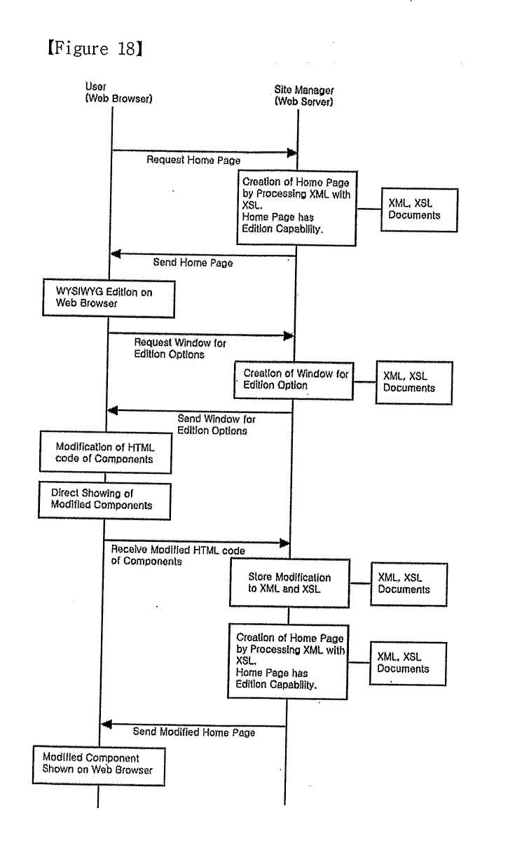

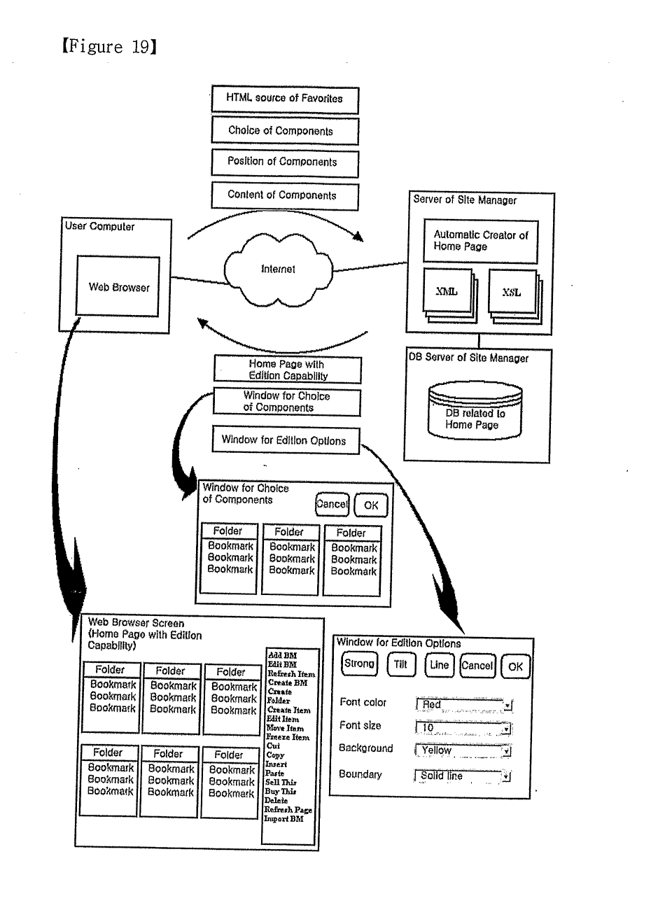

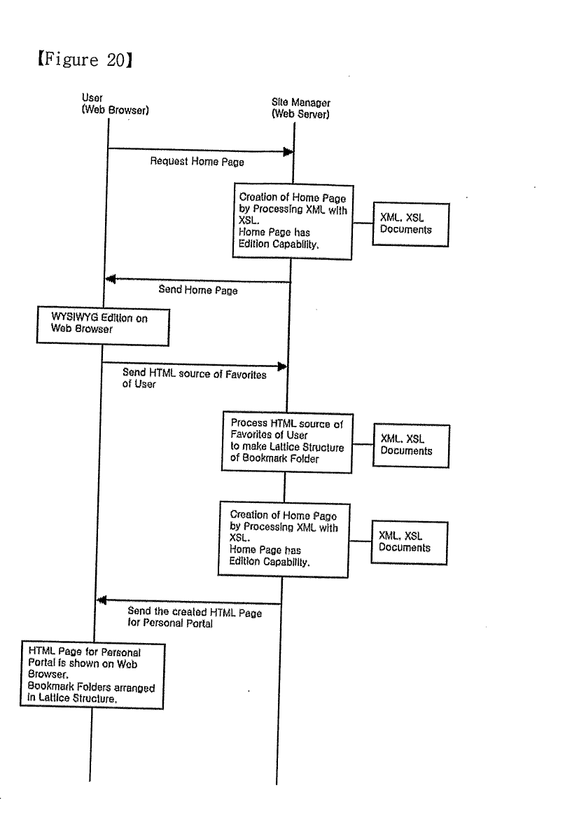

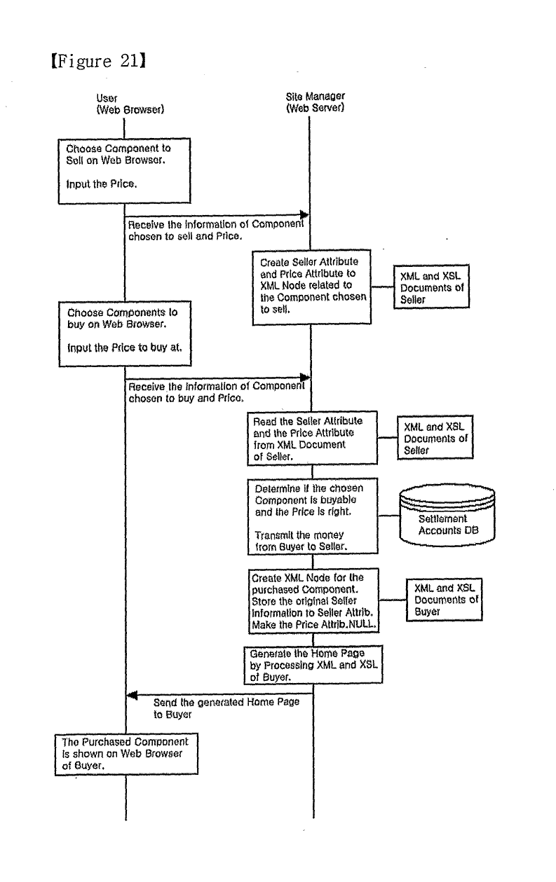

### BEST MODE

The present invention uses Apache server (version 2.0.48) as a server, PHP (version 4.3.4) as a server-side script language, MySQL (version 4.0.16) as a database, internet explorer (version 6.0) as a web browser, Window XP as an operation system. The same principle of the present invention is applied to any system in which one of the above is replaced with an equivalent program (for example, using navigator instead of the internet explorer).

The general procedure that the user visits the manager's site, joins as a member after registration, is given personal storage space (from now on, this will be called personal folder), and is given a personal internet address is same as the known method.

In the above personal folder, the XML and XSL document is given which can regenerate the editable personal home page. The first procedure of edition is done by javascript. For the user's convenience, the edit menu is given as a context menu (drawing 4). In other word, when the user clicks the mouse right button, the edit menu appears and the user can choose one of the edit menu item. The menu items on the edit menu are “creation of bookmark folder, bookmark or other home page components, “change”, “copy”, “cut”, “paste”, “delete”, “import the personal favorites” et cetra. Though the menu items for a frequent edition are directly chosen in the edit menu and executed, a separate HTML editor is sent to user for the components which are not frequently edited or need more options for edition. This HTML editor is the plain editor which edits the node of HTML document.

[Creation of Bookmark Folder]

Bookmark folder which is one of the home page components can be created as follows. When the display of web browser is mouse-right-clicked, a contextmenu appears and at the same time the position where the mouse event occurs is recorded by javascript(for example, left=10, top=20). The every parent nodes from the event node are searched to find all the registered classes (for example, “body”). Using the informations from the found component, position, and “create bookmark” command, the javascript creates a new bookmark folder node (“<div class=‘folder’ style=‘left:10; top:20; position: absolute;’><table>TABLE_STRUCTURE</table></div>”) as a child node of the found component at the position. At the same time, javascript sends the informations such as the command type, the mouse event position, the inner content (‘<table>TABLE_STRUCTURE</table>’) to the server.

On receiving these informations, the server creates an XML node(<bookmarkfolder></bookmarkfolder>) corresponding to the new bookmark folder at the XML document root. In the XML node, the position attribute (position=‘left:10; top:20; position:absolute;’) is stored and the content information (content=‘<table>TABLE_STRUCTURE</table>’) is stored. The final XML node is as follows. <bookmarkfolder position=‘left:10; top:20; position:absolute;’ content=‘<table>TABLE_STRUCTURE </table>’></bookmarkfolder >. After the creation of XML node, the XML is processed with XSL. The XSL regenerates HTML code(<div class=‘folder’ style=‘left:10; top:20; position:absolute;’><table>TABLE_STRUCTURE</table></div>) using the information stored in the XML node and sends this HTML code to the user's web browser. After the refresh of the web browser, a new bookmark folder is shown on the web browser.

### Mode for Invention

The detailed application modes are shown below.

[The Transposition of the Bookmark Folder]

To transpose the bookmark folder from one position to a new position, the ‘move’ menu item on the context menu is pressed. Then the bookmark folder can be transposed by dragging as javascript redraws the bookmark folder on every drag event. If the ‘freeze’ menu item is pressed at the final position, the informations of the final position and the path for the transposed component are sent to the server. The server, on receiving these informations, searches the corresponding XML node and replaces the old information with the new informations. The next step for the transposed component to be shown on a user's web browser is same as explained above.

When the user just wants to change only the position of the component not the content itself, only the ‘left’ and ‘top’ information is sent. Since the amount of transferred data is very small and only this information is restored at the corresponding XML node, this process is done quickly.

[Edition of the Bookmark Folder]

Each component can be edited one by one. The following example is the edition of the background of a bookmark folder. If the mouse right button is clicked on the previously-created bookmark folder, all the parent nodes from the bookmark folder where mouse event occurs are searched to find the registered classes. Finally the div node whose class is ‘folder’ will be found. The child node of this div node is the component content of bookmark folder. If the menu item ‘edit’ is pressed, an editor is sent from the server. If the ‘background’ is chosen from the menu option on the editor, the new style (<table style=‘background:#ff0000;’>BOOKMARKFOLDER_CONTENT</table>) is added to the bookmark folder.

The path information of the edited component and the content information are sent to the server. The server finds the corresponding XML node and stores the sent informations to the XML node as strings at corresponding attributes.

<bookmarkfolder position=‘left:10; top:20; position:absolute;’ content=‘<table style=’background:#ff0000;‘>BOOKMARKFOLDER_CONTENT</table>’></bookmarkfolder>. Finally the user's web browser is refreshed to show the new edited content.

[Creation of Bookmark in Bookmark Folder]

When a user finds a favorite internet site while surfing, the user just clicks the mouse-right button. Then a context menu appears with the menu item ‘add bookmark’. When this menu item ‘add bookmark’ is pressed, the information of the favorite site is stored in the clipboard of the user's computer and at the same time the web browser goes to the home page where the user has his own editable personal home page provided by the web site manager after registration as a member. When the user chooses one of the bookmark folder and clicks the mouse right button, a new context menu with the menu item ‘quick add’ is shown. When the menu item ‘quick add’ is pressed, javascript creates a bookmark node (<a href=www>BOOKMARK_TITLE</a>) in the bookmark folder node. At the same time the path of the bookmark folder and the HTML code of the bookmark node is sent to the server. The server finds the corresponding XML node and replaces the content attribute with a string of a new HTML code of bookmark node. After this the user's web browser is refreshed to show the new edited page.

[Edition of the Bookmark in Bookmark Folder]

Because the bookmark folder is stored at the content attribute of the XML as a string, the bookmarks are also stored as string. The edition for these bookmarks is done as follows. When a user selects one bookmark to be edited in bookmark folder, a mouse event occurs from that node and the path is searched to find the bookmark folder class. Then the javascript records and sends the string of bookmark before the edition and the string of bookmark after the edition to the server. The server searches the corresponding XML node in the XML document using the information sent by the user side. The string of the attribute of the XML node is read and the part of string is replaced with the edited string. The changed string is stored again in the content attribute of the XML node.

By this method only the edited bookmark content is sent to the server, the present invention reduces the transferred data amount compared with that of the previous method which send all the home page even the edited one is just part of the whole page.

[The Deletion of Bookmark Folder]

When a user wants to delete one of the bookmark folder and clicks mouse right button, the path is searched from the node where mouse event occurs. Each component has its class name according to its function. Javascript finds this node and deletes it. After that the path and command ‘delete’ is sent to the server. The server searches the XML node and deletes the found XML node.

[Copy and Paste of the Bookmark]

When a user chooses one of the bookmarks in a bookmark folder and clicks the mouse right button to show a context menu and chooses the menu item ‘copy’ on the context menu, the HTML code of the bookmark node where the mouse event occurs is copied into the clipboard of user's computer. When the user clicks mouse right button at the position where the user wants to insert the bookmark node, a context menu appears with the menu item of the command ‘paste’. When the user presses the menu item ‘paste’, javascript inserts the copied HTML code of the bookmark from the clipboard and at the same time the path of the node is searched. These two informations about the path and HTML code are sent to the server. The server finds the corresponding XML node and stores the HTML code of bookmark as a string at the content attribute of the XML node.

[Insertion of Object into a Bookmark Folder]

When a user wants to insert an object(text, picture, applet, flash et cetra), the user chooses the menu item ‘create item’ in the context menu. When the menu item ‘create item’ is pressed, a dialog window for the item selection is sent from the server. When a user selects one item from the dialog window, javascript inserts the selected component into the position where the mouse event occurs and sends the position information and HTML code of the item to the server. The server creates a new XML node corresponding to the item and stores the position information and HTML code at the position attribute and the content attribute of the XML node respectively as string.

The other function (cut, background color, background image, border style, border color, text, applet, flash) of edition is done in the similar way as explained above.

[Change of Style]

Since the XSL of the server side can store the style tag, if the information about a new style is sent to the server, the server replaces the style tag or XSL file itself with a new one. Thus a user can easily change the style of the whole document.

[Creation, Edition, and Deletion of Other Components]

The creation, edition, and deletion of other components (login window, board, album, menus, advertisement) is done in a similar way as those of the bookmark folder. The objects such as picture, applet, flash are created beforehand by professional editors and displayed for choosing on the selection dialog window. When a user selects one of the items, javascript inserts the component into the selected position. The information about insertion is sent to the server. The server creates a corresponding XML node and stores the position information at the position attribute and the HTML code for the item at the content attribute of XML node respectively as string. The other functions for edition are similar as the creation, edition, and deletion of bookmark folder.

[Creation of Portal Site]

When a user wants to have a portal site, the site manager prepares a premade portal page containing classified bookmark folders for user's convenience (drawing 5) and provides it for a user. When the user wants to have his own portal page made from hiw own bookmark favorites, the user sends the favorite file which is an HTML file(drawing 8b) made from the personal favorite records by the web browser. In addition to the HTML file, user's options (how many folder's in a column, how many bookmarks in a folder, style of bookmark or bookmark folder, the size of bookmark folder) are to the server also.

“favorites HTML file” is a web document of static tree structure which is obtained from the personal favorite records of dynamic tree structure on web browser. Though this file itself can be used directly as a personal portal page, its static tree structure makes it inconvenient for the user to use and has no edition function for each component.

The present invention manipulates this file and adds the edition function and transfers it into XML file which the server can manupulate. The present invention uses a string replacement method (drawing 9, 10) to convert the HTML document into the XML document on which a user's option (the number of the bookmark folders in column, the number of bookmarks in bookmark folder) are applied. The string replacement method can convert the HTML document into XML document by replacing the HTML tags with XML tag and additionally can change the document by inserting a new tag in front of or at the end of the selected tag as explained in the creation of bookmark folder.

The prevail web browser is Internet Explorer of Microsoft or the Navigator of Netscape. These web browsers store the user's internet favorite records as a special HTML file (HTML favorite file) This HTML file has a well-defined structure, which makes it possible to search a specific pattern of string and replaces it with another string to become XML document.

The string replacement method of the present invention can be done by two steps logically. The first step is to make the array of folder string from the favorite HTML file (drawing 9), the second step is to create a XML node on XML document from the previously-made array of folder string (drawing 10). The reason why the step of the array of folder string is needed is that if the total number of bookmarks per a bookmark folder exceeds the maximum value of the user's choice, the remaining bookmarks should be stored in a new bookmark folder and the array of string is convenient for this process.

Detailed explanation for the first step (drawing 9) is as follows. Since the string of bookmark folder starts with “<dt><h3” and ends with “<dt><p>”, if “<dt><h3” is replaced with <folder” and “</dt><p> is replaced with “</folder>”, the string of a bookmark folder is converted into “<folder>BOOKMARK_FOLDER_CONTENT</folder>”.

For the title of bookmark folder, the string “>FOLDER_TITLE</h3>” is replaced with a string “><caption>FOLDER_TITLE</caption>”. For the list, “<dl><p>” tag is replaced with empty space “” or with a string “<ul>”, To focus on the detailed replacement step of bookmark folder and bookmark, the replacement step of the folder title and conversion into a list tag is omitted for clearance in the below description.

For each bookmark in bookmark folder, the string “<dt><a” is replaced with a string “<li class=‘bookmark’><a” and a string “</a>” is replaced with a string “</a></li>”. When this replacement occurs, the number (Count) of the replaced bookmarks is recorded and checked if this value is within the maximum value (Num). If the number of bookmarks exceeds the maximum value, the bookmark conversion is done as follows.

The string “<dt><a” is replaced with a string “<folder><caption>FOLDER_TITLE</caption><li class=‘bookmark’><a” which is made by adding a string “<li class=‘bookmark’><a” to a string “<folder><caption>FOLDER_TITLE</caption>” to become a new bookmark folder with the same folder title. Of course at this step, the serial number can be added to the folder title like “FOLDER_TITLE2”. To complete the bookmark folder, the string “</a>” is replaced with a string “</a></li>” and the a string “</folder>” is added to the last part. The completed bookmark folder node (string) is stored in the array of string for the next step (drawing 8c).

In the next step (drawing 10), a corresponding XML node (drawing 8d) is created from the array of string prepared in the first step. This XML node has a position attribute and a content attribute. The position attribute is calculated from the folder number in a column, the folder width and folder height automatically and is set with the calculated value. The content attribute stores the bookmark folder string as a string. If an additional change of style for the bookmark folder is asked, the string replacement can be done at this stage. For example, the string “<caption>FOLDER_TITLE</caption>” can be replaced with “<table><caption>FOLDER_TITLE</caption><tr><td><ul>” and the string “</folder>” is replaced with “<ul></td></tr></table>”. The XML node of the bookmark folder made through these two steps, are added to the XML root (drawing 8d). The present string replacement method is done in logically simpler way than making bookmark folder and filling it with bookmarks by reading and searching all the tags in HTML favorite file.

The user's favorite bookmark file manuplated by the server as explained above, is now no longer a tree structure but a lattice structure of folders spreaded all the bookmarks in one page (drawing 5). The completed XML document is stored in each personal folder, which is processed with XSL and sent to user's web browser as HTML document on user's demand.

[The Edition of Portal Site]

The edition of style and move of classified bookmark folder by user is done in a similar way as that of the edition of hpme page components.

In this present invention, the home page component (login form, board, or album) which operates in connection with a database is connected with the database previously when it is made and displayed for user's convenience.

If a user wants an additional change to this preset connection with database, it can be done by the HTML editor sent from the server. The edition of the preset connection is done in a normal way known in public.

If a home page component is edited by the javascript, the component is shown on web borwser as edited component immediately when the edition occurs. Thus it will not be necessary to refresh the web page with the stored and edited component by the server after the edition is completed. The edition method of the present invention is that when the javascript completes its edition step, the edited component information is sent to the server, thus the home page shown on the user's web browser is exactly same as that stored in the server side. In this case the refresh of user's web browser with the HTML document sent from the server is not necessary. This saves much data traffic between the user and the server.

In the present invention, the HTML code of each component read from a web browser is stored in an attribute of the corresponding XML node as a string. It can be stored in a child node of the corresponding XML node. But one disadvantage is that the child node should be searched when processed with a XSL. This additional search makes the process inefficient. On the other hand the HTML code of each component can be stored in database as a string (drawing 3). In this case the position information (left, top coordinates) and the content information (the HTML code of component) are stored separately as in the case of the XML node. The slash “/” should be added to the string stored in a database to prevent the malfunction of database itself and this is a method known in public.

[Trading of Component]

In the present invention, each component can be created, edited and copied. Thus it is possible to trade each component (drawing 14).

A user (seller) who wants to sell his home page component to the other user sends the “price” information to the server. The server records this price information to the corresponding XML node and stores this price information at the price attribute of the XML node. If there is no seller attribute in XML node, then the server creates a seller attribute and stores the user id at this attribute. If there is already a seller attribute in XML node, the seller id is checked if these two are exactly same. If it is same, the price information is saved, but if it is not same, the price information is cancelled (drawing 11).

The price information is sent to the other user (buyer) who wants to buy the seller's home page component. If there is no seller attribute at the seller's component, then it means that this component is not for sale. If there is no price attribute (in other word, the price value is “NULL”) then it means that this component is not from the original seller so the server sends the message that the buyer should visit the original seller's home page and buys one from the original seller. If the price is “0”, it means that this component is given for free.

The buyer pays the price for a seller's component from his account in the site. The transaction between the buyer and the seller is done in the known way in public. If the transaction is done complete, then the server copies the corresponding XML node from the seller's XML document to the buyer's XML document (drawing 12). The price attribute of the copied XML node is set to “NULL” so that this copied XML node may not be sold again.

The space for the XML document to which the purchased XML node is attached is the buyer's personal folder. This XML document can be stored as a separate file or attached to the existing XML document as just a node in “buy” node (drawing 15). Only the home node in XML document is processed by XSL to become a HTML document sent to the user, the XML node in “buy” node is copied to the home node and processed with XSL on user's demand. The process for the edition of the purchased component is same as that for the other normal component. In the present invention, each XML node corresponding to each component is given an attribute for an original seller (drawing 13). This attribute cannot be editable except by the manager of the site. Whether this attribute is exactly same between that of buyer and that of seller is checked whenever an user registers a component for sale or changes the price of the component.

These components for sale can be displayed on his own personal home page or on the specific trading site which the site manager provides.

### INDUSTRIAL APPLICABILITY

By using the two fold structure of a node disclosed by the present invention, it is possible to store the HTML code designed by professional designers in a component node as a string without difficult modification procedure. The HTML code mixed with a style and content can be stored in a corresponding XML node and regenerated later on user's demand.

By using the WYSIWYG method for edition of a component on web browser, it can be made easy for a plain user to create a home page directly on web browser.

By showing the personal favorites spreaded on one page, this can be a personal portal page. A user can visit any site by just one click and can add a new bookmark easily on his own personal portal page.

By using the trading method which makes it possible to trade each component of user's home page among users, a user can be stimulated to create a more valuable component for trading. This makes the whole community of the site activated.

By using the present invention, each component can be edited at a time. This makes the data traffic small at each edition step.

1. The method for creation of home page on a web server on network comprising:
a step receiving the demand of home page from a web browser installed on the user terminal;
a step restoring the home page by processing the XML with the XSL of user's own wherein the restored home page contains the edition capability and wherein the edition menu is shown as context menu when the edition occurs;
a step sending the above home page to user's terminal;
a step editing or creating a home page component by the said user on the position where the said user chooses on a web browser;
a step receiving the created or edited home page component from the said user's terminal;
a step storing the HTML code of the said home page component in the XML and XSL document of the user's own;
a step regenerating the personal portal home page by processing the said XML with the said XSL; and
a step sending the regenerated personal portal home page to the said user's terminal.

2. The method for creation of home page on a web server on network comprising:
a step receiving a user's favorite bookmarks from a web browser installed on the user's terminal;
a step processing the said favorite bookmarks into XML and XSL document which can display a personal portal home page-XML and XSL document are created for each user;
a step regenerating a personal portal home page by processing the said XML with the said XSL wherein the regenerated home page has the edition capability;
a step sending the said regenerated personal portal home page to the said user's terminal;
a step editing or creating a home page component by the above user on the position where the said user chooses on a web browser;
a step receiving the created or edited source of the home page component from the said user's terminal;
a step storing the HTML code of the said home page component in the said XML and XSL document of the user's own;
a step regenerating the personal portal home page by processing the said XML with the said XSL; and
a step sending the regenerated personal portal home page to the said user's terminal.

3. The method for trading (“buying” and “selling”) each home page component separately of the said home page between users or between user and site manager on web server on network comprising;
a step receiving the price information from a seller's terminal;
a step checking if the seller attribute of the corresponding XML node of the target component is same as that of the sender of the price information wherein these two should be same to be enabled for trading of the chosen component;
a step creating a seller attribute and a price attribute on the corresponding XML node wherein these attributes are provided only for the components for trading and wherein the attributes is done automatically excluding the possibility for direct setting of the said attributes;
step checking if the above component is one for trading wherein the price attribute of tradable component is not NULL;
a step transmitting a settlement money from the buyer account to the seller account by accessing the account database;
a step copying the HTML source of the purchased component into the XML document of the buyer;
a step changing the price attribute into NULL while the seller attribute is left unchanged wherein a component whose price attribute is NULL is prohibited from reselling;
a step regenerating the buyer's home page by processing XML with XSL of the buyer's own; and
a step sending the generated home page to the buyer's terminal.

4. The method of claim 1, wherein the home page is divided into home page components (for example bookmark folder, bookmarks, login window, bulletin board, album, menu, advertisement, text box, image box, applet, flash et cetra) and each HTML source of the said home page component is wrapped by a tag (for best mode, “div” tag) to make a node of two fold structure (called “component node 1”) wherein a position information is stored in position attribute of the said component node.

5. The method of claim 1, wherein the creation of each home page component comprising additionally:
a step showing an edition context menu by right-click of mouse device on anywhere a user wants to place the said component;
a step choosing one of the menu item of context menu wherein the example of components are bookmark folder, bookmark, login window, album, menu, advertisement, text box, image box, applet, flash;
a step creating the chosen component based on the position and the choice information by modifying the HTML source of the home page of the web browser of user's terminal wherein the created component is shown immediately on the web browser of the user's terminal;
a step sending the position information and the HTML source of the said component to the web server; and
a step creating a new XML node for storing the received position and the HTML source.

6. The method of claim 1, wherein another method of creation of component comprising:
a step displaying a context menu by right-click of mouse device anywhere a user wants to place the component;
a step choosing one menu item on the said context menu;
a step sending the information of the choice to the server on network;
a step sending a web page containing various design of the chosen component to the user's terminal wherein these web page is previously made by a professional designer and saved on the web server of the site manager;
a step displaying the sent web page on the user's terminal;
a step pressing “confirm” button after choosing one of the design of components;
a step sending the choice information to the server; and
a step creating XML node in the XML document of user's own to store the chosen component.

7. The method of claim 1, wherein the edition method of each home page component comprising additionally:
a step choosing the component which the said user wants to edit by the right-click of mouse on the chosen component and displaying the context menu at the same time;
a step editing the chosen component using the edition menu item on the context menu wherein the edition menu items are “add”, “create” “edit”, “move”, “freeze”, “cut”, “copy”, “insert”, “paste”, “select”, “sell”, “buy”, “delete”, “refresh”. “import favorite”;
a step editing the component in WYSIWYG on a user's web browser; and
a step sending automatically the edited HTML source of the component to the server.

8. The method of claim 1, wherein another edition method comprising:
a step choosing the component which the said user wants to edit by the right-click of mouse on the chosen component and displaying the context menu at the same time;
a step choosing the “edition” menu item;
a step sending HTML editor from web server—editor is shown on separate window;
a step choosing the edition option on the said editor—the edition option are different depending on which component is chosen;
a step editing the component in WYSIWYG on the user's web browser; and
a step sending the edited HTML source to the server after edition.

9. The method of claim 1, wherein the method to store the HTML source of component in the XML document is that the position information and the content information of the component are stored as a string in the position attribute and the content attribute respectively of the corresponding XML node.

10. The method of claim 1, wherein another method to store the position and the content information of component is that the position information and the content information of the component are stored as a string in a position attribute and a content attribute respectively of the corresponding XML node by replacing the old string with a new string.

11. The method of claim 1, wherein the menu item of the context menu for edition are “add”, “create”, “edit”, “move”, “freeze”, “cut”, “copy”, “insert”, “paste”, “select”, “sell”, “buy”, “delete”, “refresh”, “import favorite”.

12. The method of claim 2, wherein the bookmark folders are displayed as lattice of folders (for best mode, 4 folders in each row).

13. The method of claim 2, wherein the bookmark folders and the bookmarks inside them are edited by choosing the menu item of a context menu displayed only when the right-click of mouse occurs.

14. The method of claim 3, wherein the XML node corresponding to the component to sell has a seller attribute and a price attribute additionally to a position attribute and a content attribute. The said two attributes are given automatically, not manually, after checking if the component is tradable or not.

15. The method of claim 3, wherein the XML node corresponding to the purchased component is copied into the buyer's XML document and the said XML document is processed with the XSL to be sent and shown on the web browser of the buyer's terminal or stored in the temporary node (called “buy node”) of XML document and processed with XSL to be shown later when the buyer want to.

16. The method of claim 1, wherein the method to store the HTML source of component is database instead of XML document storing the position information in “left” and “top” row and content information in “content” row of database as a string.

17. The method of claim 1, wherein another method to store the HTML source of component is database instead of XML storing the position information in “left” and “top” row and the content information in “content” row of database by replacing the previous string with a new string.
